(19) United States
(12) Patent Application Publication
(10) Pub. No.: US 2021/0272106 A1
(43) Pub. Date: Sep. 2, 2021

(54) Universal Payment Messaging Using Public Blockchains and Identity Platform

(71) Applicant: Metallicus Inc., San Francisco, CA (US)

(72) Inventors: Marshall Hayner, Encino, CA (US); Glenn Marïen, Hasselt (BE)

(73) Assignee: Metallicus Inc., San Francisco, CA (US)

(21) Appl. No.: 17/190,320

(22) Filed: Mar. 2, 2021

Related U.S. Application Data
(60) Provisional application No. 62/984,236, filed on Mar. 2, 2020.

(51) Int. Cl. G06Q 20/38

(52) U.S. Cl. CPC G06Q 20/389; G06Q 20/386

(57) ABSTRACT

Systems and methods are described for universal payment messaging that includes receiving an on-chain blockchain demand message, which may be in the form of a payment request, pending payment authorization, cleared payment authorization, or identity request. Processors of the demand message can communicate with user-affiliated payment applications over a universal blockchain ledger. This may be achieved by embedding an identity value for a user or business entity by storing a reference to that entity value in an on-chain smart contract. The blockchain server may also store a claim against that identity value by an identity service provider, in addition to a claim by a payment service provider or money service business that is attested to the immutable cryptographic blockchain. The messaging may be stored remotely without handling customer data, and the demand message may be authenticated by the payment service provider to the user with a payment application.

### CROSS-REFERENCE TO RELATED APPLICATIONS

This application claims the benefit of U.S. Provisional Application No. 62/984,236, filed Mar. 2, 2020, which is incorporated herein in its entirety.

### TECHNICAL FIELD

Embodiments herein relate generally to decentralized network computing, and more specifically to using blockchain databases and an identity platform to establish secure universal payment messaging between e-commerce platforms over network communications.

### SUMMARY OF THE INVENTION

Systems and methods are described providing universal payment messaging via a blockchain server and identity values stored on the server. A server that includes a cryptographic blockchain database and which is a node of an associated blockchain network may receive an on-chain demand message from a requesting application over a network connection. The on-chain demand message may include a reference to an identity value, the identity value having been previously stored in the blockchain in an on-chain smart contract. The on-chain demand message may further include a claim against the identity value by an identity service provider and a claim for information associated with the identity value. Examples of demand messages may include, for example, payment requests from an entity to a payment application, pending payment authorizations from one user or entity to another user or entity, cleared payment authorizations from a payment application, or identity requests for a user associated with the identity value.

The server may then receive a request, by an authorizing application over the network connection, for on-chain messages referencing a first set of identity values, the first set of identity values including the identity value referenced in the received on-chain demand message. The request from the authorizing application may be a scheduled to occur in predetermined time intervals, or may be in response to the authorizing application being notified that a demand message has been posted for an identity value associated with the authorizing application. In response to the receiving the request, the server may transmit information extracted from the received on-chain demand message to the authorizing application. The extracted information may include the identity value and the claim for information associated with the identity value. After the authorizing application processes the authorization, the server may receive an on-chain authorization message from the authorizing application, the authorization message from the authorizing application including an authorization to release the information associated with the identity value to the requesting application. The information released, may be, for example, authorization for the requesting application to transfer a specified amount of a cryptocurrency requested in the demand message. In another embodiment, the information released may be validation of the identity of the user associated with the identity value.

The server may subsequently receive a request by the requesting application for on-chain messages referencing a second set of identity values, the second set of identity values including an identity value associated with the requesting application. In response to the request referencing the second set of identity values, the server may transmit information extracted from the on-chain authorization message to the requesting application.

### BRIEF DESCRIPTION OF THE FIGURES

This disclosure is illustrated by way of example and not limitation in the figures of the accompanying drawings, in which like references indicate similar elements, and in which:

FIG. 1 shows a flow diagram for a method for performing a transaction using universal payment messaging, according to an embodiment.

FIG. 2 shows a simplified block diagram of a system for universal payment messaging via a immutable blockchain and a identity values stored on the blockchain server, according to an embodiment.

FIGS. 3A-C display screenshots illustrating various interfaces of an application that utilizes universal payment messaging, in accordance with an exemplary embodiment.

FIG. 4 shows a flow diagram for a method of executing a payment request using universal payment messaging and identity values stored on a blockchain server, according to an embodiment.

FIG. 5 shows a simplified block diagram of a system executing a payment request using universal payment messaging and identity values stored on a blockchain server, according to an embodiment.

FIG. 6 shows a flow diagram for a method of processing a payment to a user associated with an identity value stored on a blockchain server using universal payment messaging, according to an embodiment.

FIG. 7 shows a simplified block diagram of a system processing a payment to a user associated with an identity value stored on a blockchain server using universal payment messaging, according to an embodiment.

FIG. 8 shows a flow diagram for a method of verifying an identity of a user associated with an identity value stored on a blockchain using universal payment messaging, according to an embodiment.

FIG. 9 shows a simplified block diagram of a system verifying an identity of a user associated with an identity value stored on a blockchain using universal payment messaging, according to an embodiment.

FIG. 10 shows a flow diagram for a method of associating funding methods with an identity value stored on a blockchain, according to an embodiment.

FIGS. 11A-B show simplified block diagrams of a chain of digital signatures of a plurality of transactions and a proof-of-work system, respectively, according to various embodiments.

FIG. 12 is a block diagram of an exemplary system for a system for universal payment messaging via a immutable blockchain and a identity values stored on the blockchain server, according to an embodiment.

### DETAILED DESCRIPTION

The Decentralized Finance movement (or “DeFi”) has run into several major obstacles to mass adoption and development. The cost of transactions have risen exponentially and unpredictably with the markets, thus limiting the potential for micro transactions or embedding identity from large to small corporations. One solution proposed by Origin Protocol, Inc., headquartered in San Francisco, Calif., is the usage of meta-transactions and relays to process those transactions. However, when and how those transactions eventually get processed is unclear. Another proposal is EIP-1559, which lowers fees by preventing gamification from miners by burning the actual fee and only accepting the ‘tip’, a nominal amount selected by the user. Unfortunately, this further exacerbates the situation of rising costs of fees and thus only delays the transaction cost problem.

To address these and other problems of conventional solutions, the use of identity values stored on the blockchain server may allow for experimentation with decentralized sovereign identity, payment flows, and transaction monitoring by extending the existing Ethereum codebase. Furthermore, the identity values may provide a bridge from legacy payment protocols (e.g., automated clearing house [ACH], Single Euro Payments Area [SEPA], Society for Worldwide Interbank Financial Telecommunication [SWIFT], etc.) and services to modern protocols and services (blockchain-based cryptocurrencies). The described identity values may remove the concept of sharing private keys (e.g., bank identification and bank account numbers) directly with merchants, instead creating a permission-less layer that exists on top of traditional card networks and banks. The described identity values permit entities, banks, and regulators of the world to experiment with the concept of monetary systems existing on public blockchain ledgers, before moving into production. In the case of governments experimenting with digital national currency, the described identity values may provide a sandbox before setting sovereign digital currencies into motion as national currencies existing on a blockchain (nation-state sponsored cryptocurrencies).

Governance of the blockchain may be modeled after the Maker (MKR) concept on Ethereum in an embodiment, and dedicated towards leveraging the wisdom of the crowd. In order to vote on risk management, business logic and technical development decisions, one can cast a vote through locking the identity values into the governance contract. Items that will be voted on may include (a) requests for comment, (b) mining rewards, (c) staking reward, and (d) grants to be offered in order to establish further users, organizations and developers on the platform. Mining may be divided into a hybrid proof-of-work, proof-of-stake, and merged-mined model against a separate cryptocurrency, in which all three make up 75% of the block reward, and the remaining 25% may be against a treasury of a managing organization, for example.

In a world fully entangled in the digital transformation, loss of control over one's identity information is becoming a rampant problem. The described identity values may solve this problem by providing a platform to register one's identity and the accompanying sensitive information in a fully decentralized, yet controlled, manner. The owner of this identity has the ability to choose when and what information is shared. An inversion of control is at the center of this idea, effectively giving back control of the information to the entity (i.e., the individual) it belongs to. The owner maintains the private key in confidence, while permitting institutions who wish to authenticate the owner to check with trusted institutions via public keys. The verification from the trusted institution may confirm the owner's identity without revealing the owner's associated private key.

An identity can be established by any entity, which may be either an individual or a business. Exemplary commands that may be transmitted to the blockchain server in on-chain messages are displayed in Table 1.

TABLE 1
Exemplary Specification for Identity Values
Identity Proxy

| | |
|---|---|
| address public owner; | Returns owner of the identity value |
| function changeOwner(address_owner); | Changes owner of the identity value, can only |
| | be called by the current owner |
| | Triggers OwnerChanged event |
| getData(bytes32_key) external view returns | Returns data of the identity value stored at a |
| (bytes_value); | specific key |
| function setData(bytes32_key, | Stores data at a specific key, can only be used |
| bytes calldata_value) external; | by the owner of the identity value |
| | Triggers DataChanged event |
| function execute(uint256_operationType, | Executes an operation on behalf of the |
| address_to, uint256_value, bytes_data) | identity value, can only be called by the |
| external; | owner. |
| | The operationType should be one of the |
| | following: |
| | 0 for call type transactions |
| | 1 for create type transactions |

The identity commands may be used in smart contracts executed on-chain, in an exemplary embodiment. The commands may be processed on the blockchain server that receives the block including the commands, or by a different server in communication with the blockchain server, in various embodiments.

An identity value can have one or more claims made against it. These claims can be self-attested or attested by a third party. Claims attested by third parties may have to be approved by the claim holder, in an exemplary embodiment. Examples of claims may include a claim holder claiming ownership of a certain social media handle (an example of self-attestation). Another example may be a claim made by a social media platform entity claiming that a user associated with a specified identity value owns a specified account on the social media platform; this is an example of an attestation by a third party. Another third-party claim may take the form of a financial institution claiming a specified identity value is associated with a user holding a valid government-issued ID. Exemplary commands that may be transmitted to the blockchain server in on-chain messages relating to claims are displayed below, in Table 2.

TABLE 2
Exemplary Specification for claims made against identity values
Claim

| | |
|---|---|
| topic | Tonic of this claim, examples: |
| | Proof of residence |
| | Biometric data |
| | Social security number |
| | . . . |
| | The topic essentially describes what this claim |
| | is about. |
| schema | Defines how the claim should be verified, |
| | examples: |
| | Contract call where data will be the |
| | call data |
| | ECDSA |
| | . . . |
| issuer | The identity behind issuing this claim which |
| | has to be the same key that was used to build |
| | the signature. |
| signature | Signature generated by the issuer using the |
| | claim's data. |
| data | Data about this claim, to be used in |
| | conjunction with the scheme. Can be a hash of |
| | the data behind this claim or the actual data |
| | itself. |
| uri | The location of this claim, examples: |
| | IPFS hashes |
| | HTTP links |
| | . . . |

Virtual asset service providers (“VASPs”), as referred to herein, may include entities that deal with the transmission of virtual assets. Usually these are financial institutions transmitting and storing funds on behalf of their customers. Registered VASPs on the described identity value network may be able to perform the following actions:
request payments from other VASPs on behalf of their customers, similar to an ACH or SEPA debit;
send payments to other VASPs on behalf of their customers, similar to an ACH or SEPA credit;
share transaction related data to comply with the FATF travel rule using a standardized format; and
share customer information related data to comply with Know Your Customer (“KYC”) requirements.

In an exemplary embodiment, the identity value network may incorporate the public-key infrastructure provided by Ethereum. In such embodiments, each registered VASP may have a 160-bit public key linked to a smart contract associated with the VASP. The public key, which may be prefixed with “θx” for readability, may serve as the main identifier of the VASP. Since a 160-bit hexadecimal code can be cumbersome and inefficient to use, a routing code similar to how BIC/SWIFT codes identify financial institutions may be used to refer to the public key. This code, which may be defined as a “VIC” (VASP identifier code), may be assembled using the last 32 bits of the public key and allows for a more usable form of identifying VASPs. For example, a 160-bit VASP public key may be:

0x8dEB12D8774d22a53FdD1Be3314e9384851139BD.

The corresponding VASP Identifier Code (last 32 bits) for this public key may be 851139BD.

As previously described, the last 32 bits of the main identifier may be used as the VASP identifier code. This does however create a potential attack vector where a malicious user could try and generate a public key where the last 32 bits equal an existing VASP's identifier code. To mitigate this risk, a VASP Identifier Code Registry may be used, where VASPs register and effectively claim their identifier code. A unique identifier code may only be registered once with the Identifier Code Registry. This code registry may be a decentralized registry in the form of an Ethereum smart contract using the interface shown below, in Table 3.

TABLE 3
VASP Registry On-Chain Smart Contract
VaspRegistry

+ vasps: mapping (bytes4 => address)
+ register(address)
+ resolve(bytes4)

The register( ) function may receive the address parameter as input, and may add the address to the VASP list using the last 32 bit as the mapping key. The resolve( ) function may receive the 32 bit key as input, and return the matching address.

Traditionally, the next step, defining a method of identifying which customer a request relates to, is accomplished with an account number that allows the VASPs to tie the request to a customer. In an exemplary embodiment, this may be done for the identity value network using a Virtual Assets Account Number (“VAAN”). This account number may be generated using the existing VASP Identifier Code (VIC) associated with the request, and a 56-bit Customer Identifier (“CI”):

VAAN=VIC+CI+CheckSum8 Mod 256(VIC+CI)

Furthermore, a VAAN may be assigned permissions, such as a debit permission (allowing the customer associated with the VAAN to send funds) and/or a credit permission (allowing the customer associated with the VAAN to receive funds). An example of a how a VAAN can be generated is displayed below in Table 4.

TABLE 4
Step-by-step Derivation of VAAN from
requesting VASP VIC and customer CI.

| | |
|---|---|
| VASP Identifier Code (last 32 bits) | Customer Identifier (56-bit) |
| 8511 39BD | AB09 3E9C 01DA 94 |

Concatenated string
8511 39BD AB09 3E9C 01DA 94
Checksum8 Mod 256 of concatenated string
89
VAAN
8511 39BD AB09 3E9C 01DA 9489

The customer identifier can be chosen at random by the VASP. Typically a customer has a single account number, but it may depend on which level of privacy the customer wants to achieve. The VASP could go as granular as generating a unique VAAN per transfer in order to achieve a higher level of privacy, in some embodiments.

VASPs need to be able to communicate with each other over a secure and authenticated channel. Ethereum comes with a built-in messaging protocol called Whisper, which establishes a secure communication channel in a P2P environment and offers a high level of privacy as messages are encrypted using the public key of the recipient. The general principle of Whisper consists of a network of nodes broadcasting encrypted envelopes to one another. Every participating node on the network will receive every single envelope transmitted by other nodes. However, since these envelopes are encrypted using the public key of the recipient, the recipient is the only node capable of decrypting the payload. Decrypting every single message can be quite resource intensive, so a topic filter is used to make sure the VASP's Whisper node only decrypts messages sent to its topic. The topic we will be using is the VASP Identifier Code, the 32-bit short identifier explained above.

Operating as a VASP may come with regulatory obligations; one is the Travel Rule defined by the Financial Action Task Force (FATF) or Bank Secrecy Act (BSA) defined by FinCEN. The described identity value network may provide a platform to efficiently exchange information between trusted VASPs to comply with the Travel Rule enforced by the FATF and FinCEN. The key characteristics behind this may be A) a standardized data format regarding originator and beneficiary information, and B) a protocol that defines the data exchange between VASPs.

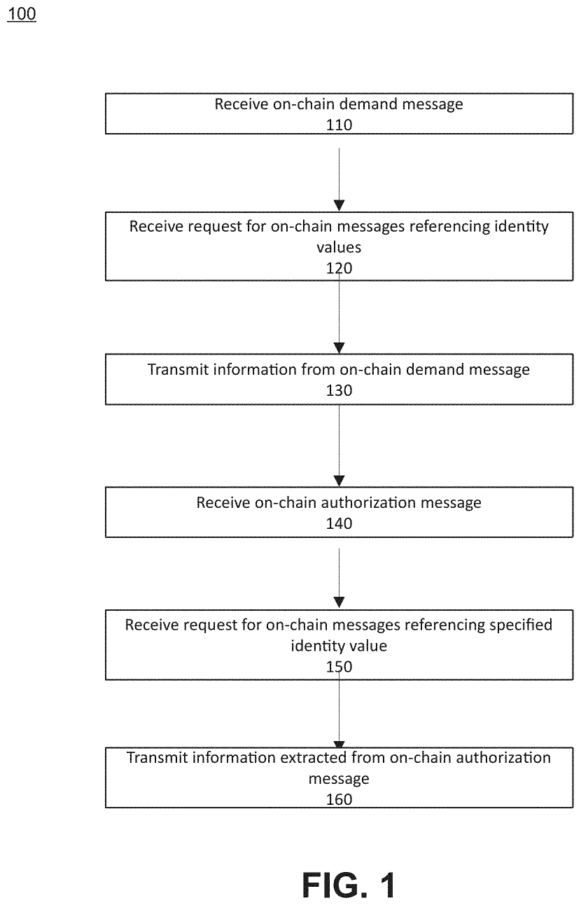

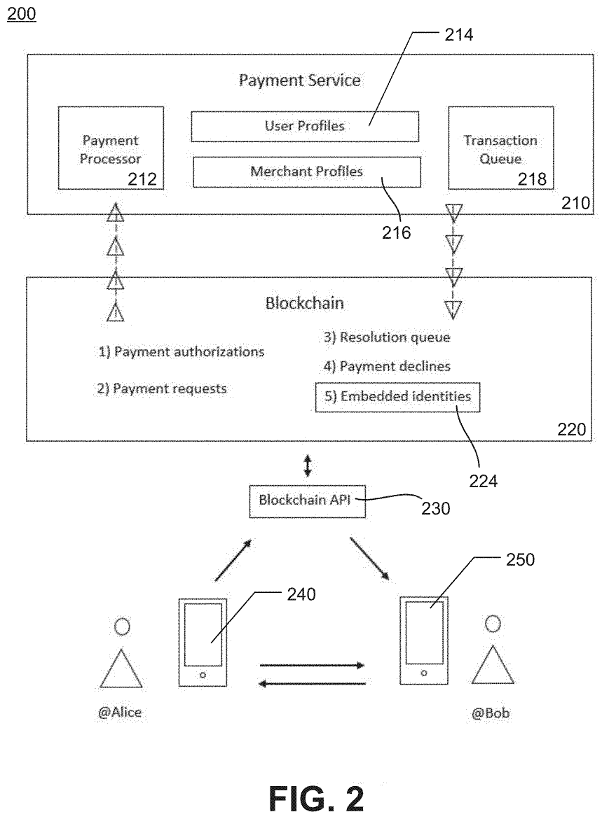

Methods for improving efficiency of transactions using universal payment messaging and identity values stored on a blockchain server are described herein. FIG. 1 shows a flow diagram for a method 100 for performing a transaction using universal payment messaging, according to an embodiment. FIG. 2 shows a simplified block diagram of a system 200 for universal payment messaging via a immutable blockchain and a identity values stored on the blockchain server, according to an embodiment, using the method 100 described in FIG. 1. The exemplary system 200 includes a payment service server 210 in communication with blockchain server 220 over a network connection. The payment service server 210 may include a plurality of profiles, including profiles 214 for individual customers using the payment service associated with the payment service server 210 and profiles 216 for merchants and/or business entities using the payment service. The payment service server 210 may also include a payment processor 212, which receives incoming payment message information from the blockchain server 220, and transaction queue 218, which may store a list of transactions to be pushed to the blockchain server 220.

In addition to communicating with the payment service server 210, the blockchain server may store a blockchain database (as a node of a blockchain network), and may also be in communication with user computing devices 240 and 250 via blockchain APIs 230. The blockchain database may store messages within each block of the blockchain, including messages pertaining to payment authorizations, payment requests, and payment declines, for example. The blockchain sever may also store a resolution queue, documenting the resolution of various transactions reflected by the payment messaging on the blockchain. The resolution queue may include references to blocks in the blockchain, in some embodiments, while it may be completely distinct in other embodiments. The blockchain APIs 230 may be used by the user computing devices 240 and 250 to set up and interact with embedded identity values 224 (described above) corresponding to the user computing devices 240 and 250 respectively. While exemplary payment message system 200 is shown as having a single payment service server 210 and a single blockchain server 220, the invention is not limited in this regard, as each depicted server may include a network of multiple servers.

Returning to FIG. 1, the method 100 may start at step 110, where the blockchain server 220 may receive an on-chain demand message from a requesting application (e.g. the transaction queue 218 running on payment service server 210) over a network connection. The on-chain demand message may include a reference to an identity value, the identity value having been previously stored in the blockchain in an on-chain smart contract (e.g., as an embedded identity value stored with the identity values 224). The on-chain demand message may further include a claim against the identity value by an identity service provider and a claim for information associated with the identity value. Examples of demand messages may include, for example, payment requests from an entity to a payment application, pending payment authorizations from one user or entity to another user or entity, cleared payment authorizations from a payment application, or identity requests for a user associated with the identity value.

The blockchain server 220 may then receive a request, by an authorizing application (e.g. a payment processor, such as payment processor 212 of payment service server 210, of a different payment service server) over the network connection, for on-chain messages referencing a first set of identity values at step 120. The first set of identity values may include a subset of user profiles stored on the different payment service server, which may include the identity value referenced in the received on-chain demand message. The request from the authorizing application may be a scheduled to occur in predetermined time intervals, or may be in response to the authorizing application being notified that a demand message has been posted for a identity value associated with the authorizing application.

In response to the receiving the request, the blockchain server 220 may transmit information extracted from the received on-chain demand message to the authorizing application at step 130. The extracted information may include the identity value and the claim for information associated with the identity value. After the authorizing application processes the authorization, the blockchain server may receive an on-chain authorization message from the authorizing application at step 140, the authorization message from the authorizing application including an authorization to release the information associated with the identity value to the requesting application. The information released, may be, for example, authorization for the requesting application to transfer a specified amount of a cryptocurrency requested in the demand message. In another embodiment, the information released may be validation of the identity of the user associated with the identity value.

The blockchain server 220 may subsequently receive a request by the requesting application (e.g., payment processor application 212) for on-chain messages referencing a second set of identity values, the second set of identity values including an identity value associated with the requesting application. The identity value may be one of the identity values stored in merchant profiles 216, for example, for a payment directed towards a merchant associated with the payment service server 210. In response to the request referencing the second set of identity values, the blockchain server 220 may transmit information extracted from the on-chain authorization message to the requesting application at step 160.

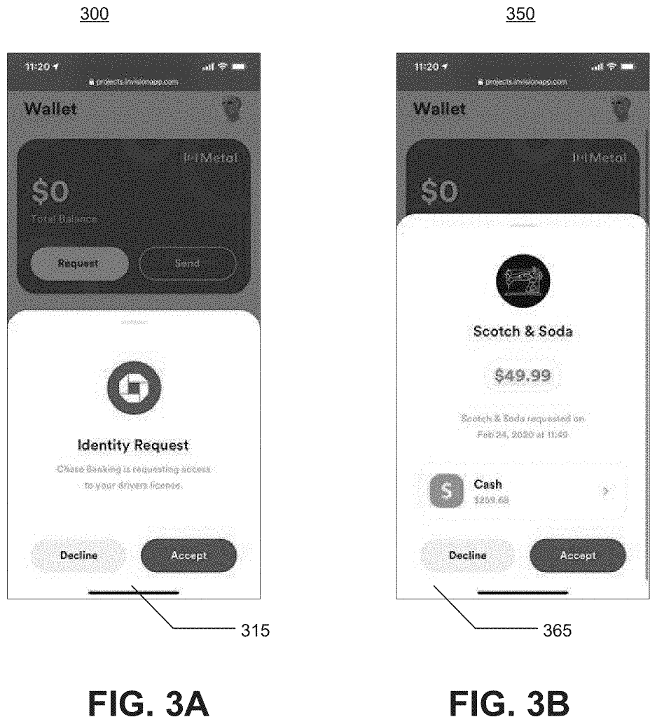

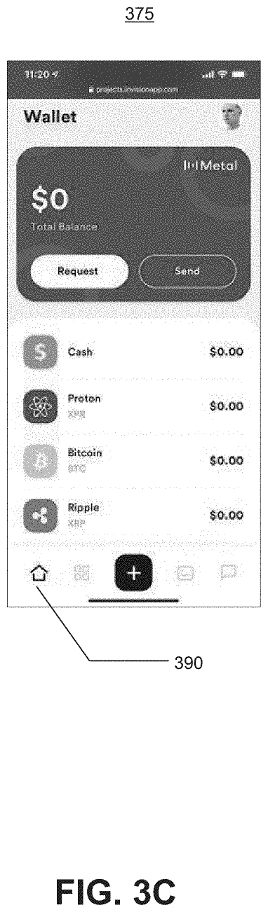

FIGS. 3A-C show screenshots 300, 350, and 375 illustrating various interfaces of an application that utilizes universal payment messaging and the identity values discussed in method 100, according to various embodiments. The application may be running on a user computing device, such as devices 240 and 250 of system 200, in communication with both the payment service server 210 and the blockchain server 220 over a network connection. Interface 315 displays a request from a payment service server 210 (i.e. a KYC provider) for identification information. The request may be information extracted from an on-chain message, or may be a direct request from a payment service server 210 (e.g., as part of a sign-up process for creating an identity value for the user).

Interface 365 depicts information extracted from a demand message, in the form of an alert on a computing device, stating that a VASP is requesting $49.99 in US dollars, and providing the option to decline or accept the demand. Interface 365 would be generated on the user's computing device based on information provided by the user's payment service, including the amount and denomination of the requested payment. Interface 390 shows a user's profile, associated on the blockchain server 220 with the identity value for the displayed user. Interface 390 may be accessed by the user, for example, using an application in communication with the blockchain server 220 over a network connection via blockchain APIs 230. All three of interfaces 315, 365, and 390 may display information based on requests made in on-chain messages

Method 100 may be the foundation for a variety of different transactions that may be facilitated using the universal payment messaging and the identity values stored by the blockchain server. For example, a beneficiary VASP can request funds on behalf of another customer from another originating VASP. In traditional payments systems this could be compared to an ACH or SEPA debit request. A beneficiary VASP can initiate a payment request (which would be the demand message from method 100) using the VAAN provided by the originating VASP, similar to how merchants can collect payments using the account and routing number on the ACH payments network. The VAAN, in some embodiments, does not even need to be known by the beneficiary VASP; instead the identity value associated with the customer can be used, and the VAAN may be generated by the blockchain server in response to receiving the demand message requesting payment.

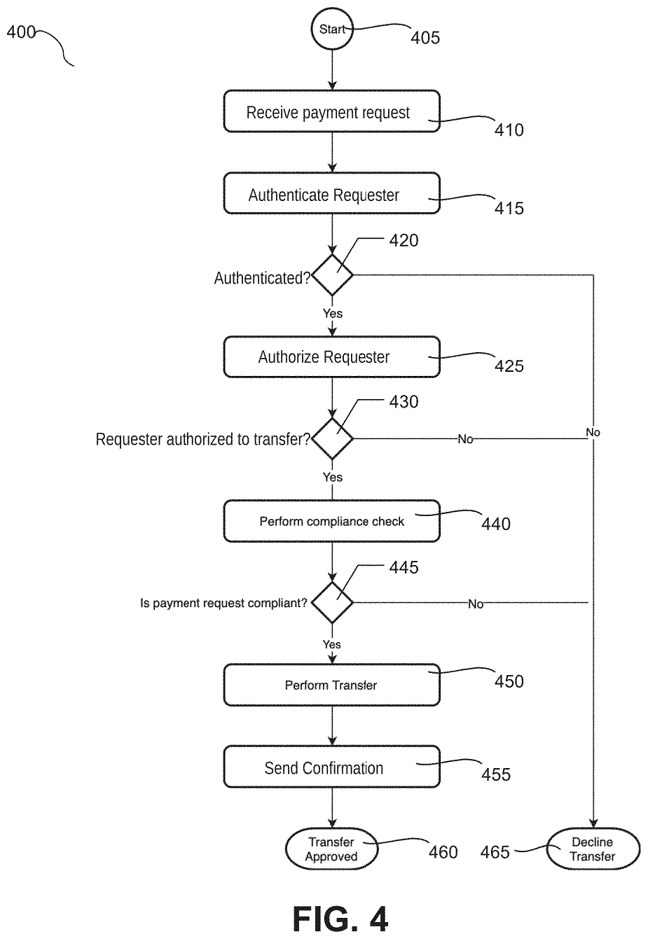

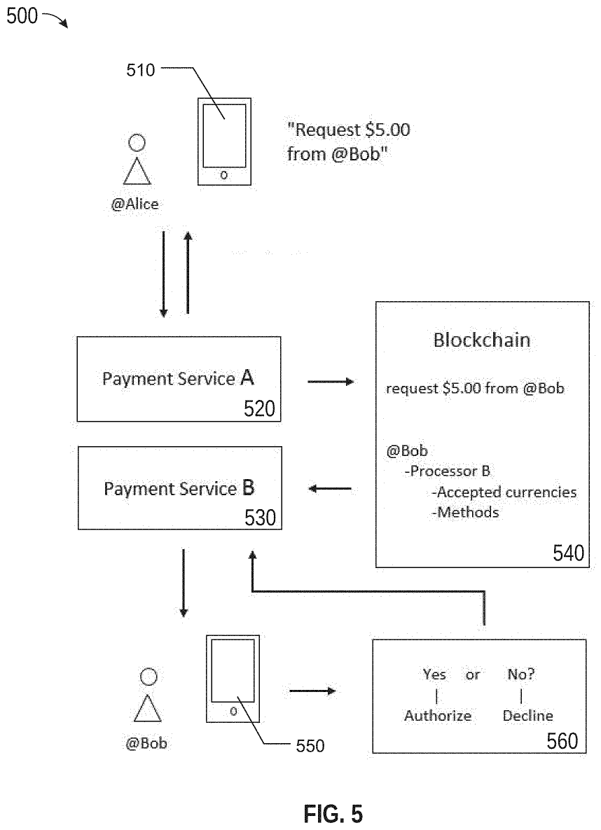

FIG. 4 shows a flow diagram for a method 400 for performing a transaction using universal payment messaging, according to an embodiment. FIG. 5 shows a simplified block diagram of a system 500 for universal payment messaging via a immutable blockchain and a identity values stored on the blockchain server, according to an embodiment, using the method 400 described in FIG. 4. The exemplary system 500 includes payment service servers 520 and 530 in communication with blockchain server 540 over a network connection. The payment service server 520 is in communication with user computing device 510, associated with a user having an identity value “@Alice.” User computing device 510 may be executing an application to communicate with the payment service 520, and may use the application to transmit the payment request for $5.00 from the user associated with the identity value “@Bob.” The user associated with the identity value @Bob may be associated with payment service server 530, as shown in system 500.

Returning to method 400, after the start 405, the payment request may be received by the blockchain server 540 from the payment service server 520, which received the demand message from the user device 510. The demand message (i.e. payment request, in the embodiment of method 400) is from the user associated with the identity value @Bob, where the request is for a specified denomination (US dollars) and a specified amount (5). The payment request may include KYC information specific to the user associated with identity value @Alice. At step 415, the requesting application (which may be running on the payment service server 520, and may include the functionality of transaction queue 218) may be authenticated by the blockchain server 540 and the authorizing application running on payment service server 530. This may be done, for example, by the authorizing application, on behalf of the originating VASP, comparing the signature of the payment request and the VASP registry stored on the blockchain server 540 to ensure that the beneficiary VASP is registered with the VASP registry.

If the blockchain server authenticates the requesting application at decision block 420 as having been previously registered with the blockchain server 540 and having a valid VID, the authorization process is triggered at block 425. If the application associated with the payment service server 520 has not registered with the blockchain server 540, then the transfer may be declined at block 465. The authorization process 425 may take place on payment service server 530, by an authorizing application performing the functionality of payment processor 212, in communication with the computing device 550 associated with the identity value @Bob. The authorizing application running on payment service server 530 may be associated with an entity (e.g. Processor B) linked to the identity value @Bob via a user profile stored on the blockchain server 540. As shown in blockchain server 540, the user profile for identity value @Bob may further specify that the entity Processor B is associated with the specified denomination in the demand message, US dollars, for @Bob.

To perform the authorization, the authorizing application may convey the information extracted from the demand message (e.g. the $5 request, and the fact that the request is from a user associated with the @Alice identity value) to computing device 550. A user interface 560 may be displayed on the computing device 550, giving the user the ability to authorize or decline the payment request (another example of user interface 560 may be seen in screenshot 350, described above). The user's response to receiving user interface 560 may be conveyed to the authorizing application running on payment service server 530, which may subsequently convey the user's response back to the blockchain using an on-chain authorization message. If the user responds by authorizing the payment request, the method 400 may proceed to step 440; if the user declines the payment request, the transfer is declined at step 465. In addition to the foregoing, the authorizing application may enforce additional policies (e.g., by maintaining a blacklist of VASPS it will automatically decline authorization for, without user input) as part of the authorization process.

At step 440, the blockchain server 540 may perform a compliance check, to see if the payment request complies with applicable regulations, for example, as described above. This involves making a risk assessment based on the KYC information provided by the beneficiary VASP. When the risk assessment checks out, the transfer will be facilitated, and a transfer confirmation will be sent to the beneficiary VASP in a standardized format. If the payment request complies with the regulations applied at decision block 445, then the transfer may be added to the blockchain via an authorization message at step 450. The on-chain authorization message may indicate that the entity associated with the authorization application (e.g., payment service B) authorizes release of the specified amount of the specified denomination (e.g. $5). If the payment request fails the compliance check at block 445, then the transfer is declined at block 465. The transfer performance 450 may also trigger adjustments to the amounts listed in the user profile associated with identity value @Bob in some embodiments.

At step 455, confirmation may be sent to the requesting application running on the payment service server 520 that the payment request has been authorized by the authorizing application running on payment service server 530. In some embodiments, this confirmation may include information extracted from the on-chain authorization message. Also, in some embodiments, the confirmation may be sent in response to a request for on-chain messages referencing an identity value associated with payment service A. Finally, the transfer may be approved at step 460 by the requesting application. Periodically, there may be settlement transactions between payment service A and payment service B after step 460 takes place, to actually transfer the requested amount in the requested denomination, as is conventionally done using legacy payment protocols.

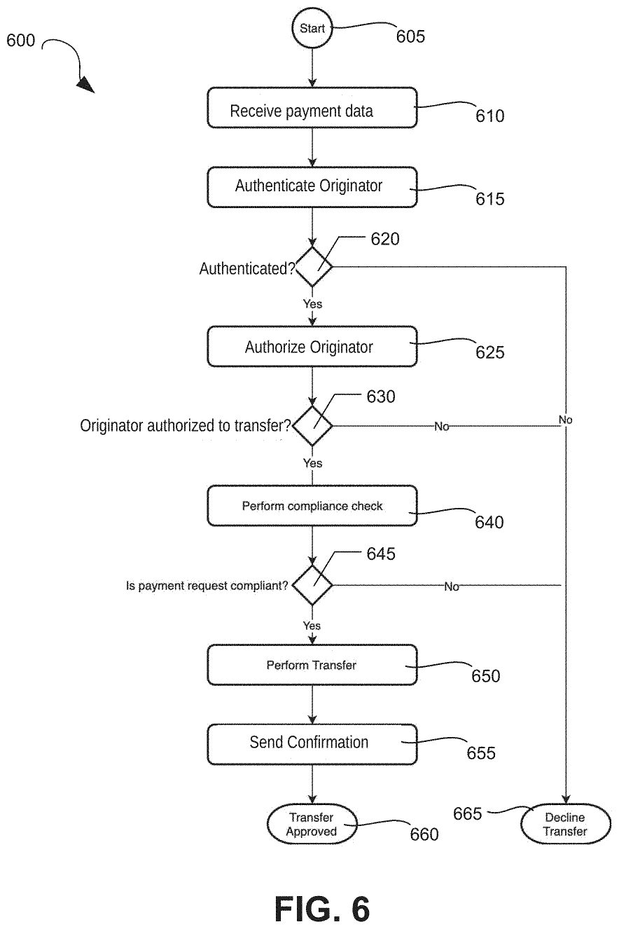

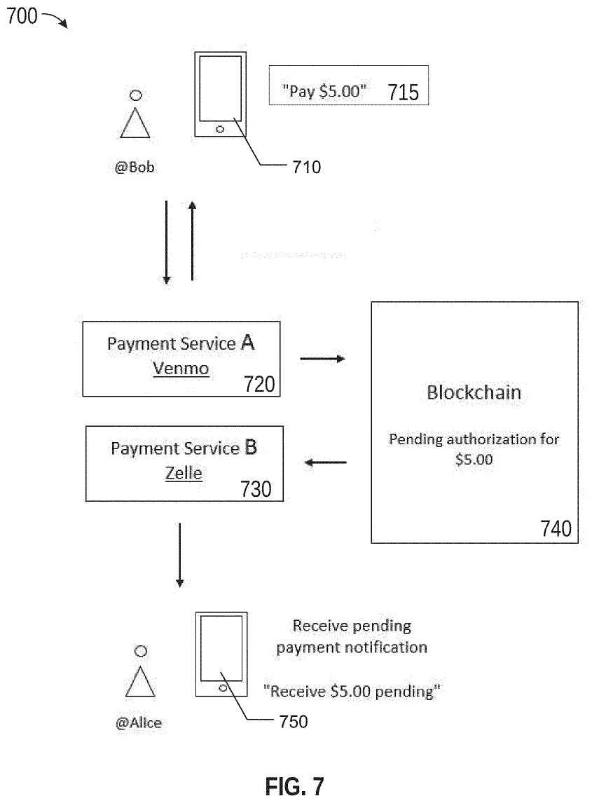

Sending payments involves the originating VASP pushing funds into the beneficiary VASP by using the VAAN of the beneficiary. It works very similar to how the payment request flow works, however in this case the initiating party is reversed. FIG. 6 shows a flow diagram for a method 600 for processing a payment using universal payment messaging, according to an embodiment. FIG. 7 shows a simplified block diagram of a system 700 for universal payment messaging via a immutable blockchain and a identity values stored on the blockchain server, according to an embodiment, using the method 600 described in FIG. 6. The exemplary system 700 includes payment service servers 720 and 730 in communication with blockchain server 740 over a network connection. The payment service server 720 is in communication with user computing device 710, associated with a user having an identity value “@Bob.” User computing device 710 may be executing an application to communicate with the payment service 720, and may use the application to transmit the grant 715 authorizing payment for $5.00 to the user associated with the identity value “@Alice.” The user associated with the identity value @Alice may be associated with payment service server 730, as shown in system 700.

Returning to method 600, after the start 605, the payment request may be received by the blockchain server 740 from the payment service server 720, which received the demand message from the user device 710. The demand message (i.e. payment request, in the embodiment of method 600) is from the user associated with the identity value @Bob, where the request is for a specified denomination (US dollars) and a specified amount (5). The payment request may include KYC information specific to the user associated with identity value @Alice. At step 615, the requesting application (referred to in method 600 as the originating application, which may be running on the payment service server 720, and may include the functionality of transaction queue 218) may be authenticated by the blockchain server 740 and the authorizing application running on payment service server 630. This may be done, for example, by the authorizing application, on behalf of the beneficiary VASP, comparing the signature of the payment request and the VASP registry stored on the blockchain server 740 to ensure that the beneficiary VASP is registered with the VASP registry.

If the blockchain server authenticates the requesting application at decision block 620 as having been previously registered with the blockchain server 740 and having a valid VID, the authorization process is triggered at block 625. If the application associated with the payment service server 720 has not registered with the blockchain server 740, then the transfer may be declined at block 665. The authorization process 625 may take place on payment service server 730, by an authorizing application performing the functionality of payment processor 212, in communication with the computing device 750 associated with the identity value @Alice. The authorizing application running on payment service server 730 may be associated with an entity (e.g. Zelle) linked to the identity value @Alice via a user profile stored on the blockchain server 740.

To perform the authorization, the authorizing application may convey the information extracted from the demand message (e.g. the $5 grant, and the fact that the request is from a user associated with the @Bob identity value) to computing device 750. A user interface may be displayed on the computing device 750, informing the user associated with the @Alice identity value that receipt of $5 is pending. The user's response to receiving the user interface may be conveyed to the authorizing application running on payment service server 730, which may subsequently convey the user's response back to the blockchain using an on-chain authorization message. If the user responds by authorizing the payment grant, the method 600 may proceed to step 640; if the user declines the payment request, the transfer is declined at step 665.

At step 640, the blockchain server 740 may perform a compliance check, to see if the payment request complies with applicable regulations, for example, as described above. This involves making a risk assessment based on the KYC information provided by the originator VASP. When the risk assessment checks out, the transfer will be facilitated, and a transfer confirmation will be sent to the originator VASP in a standardized format. If the payment request complies with the regulations applied at decision block 645, then the transfer may be added to the blockchain via an authorization message at step 650. The on-chain authorization message may indicate that the entity associated with the authorizating application (e.g., Zelle) authorizes receipt of the specified amount of the specified denomination (e.g. $5). If the payment request fails the compliance check at block 645, then the transfer is declined at block 665. The transfer performance 650 may also trigger adjustments to the amounts listed in the user profile associated with identity value @Alice in some embodiments.

At step 655, confirmation may be sent to the originator application running on the payment service server 720 that the payment request has been authorized by the authorizing application running on payment service server 730. In some embodiments, this confirmation may include information extracted from the on-chain authorization message. Also, in some embodiments, the confirmation may be sent in response to a request for on-chain messages referencing an identity value associated with Venmo. Finally, the transfer may be approved at step 660 by the originator application.

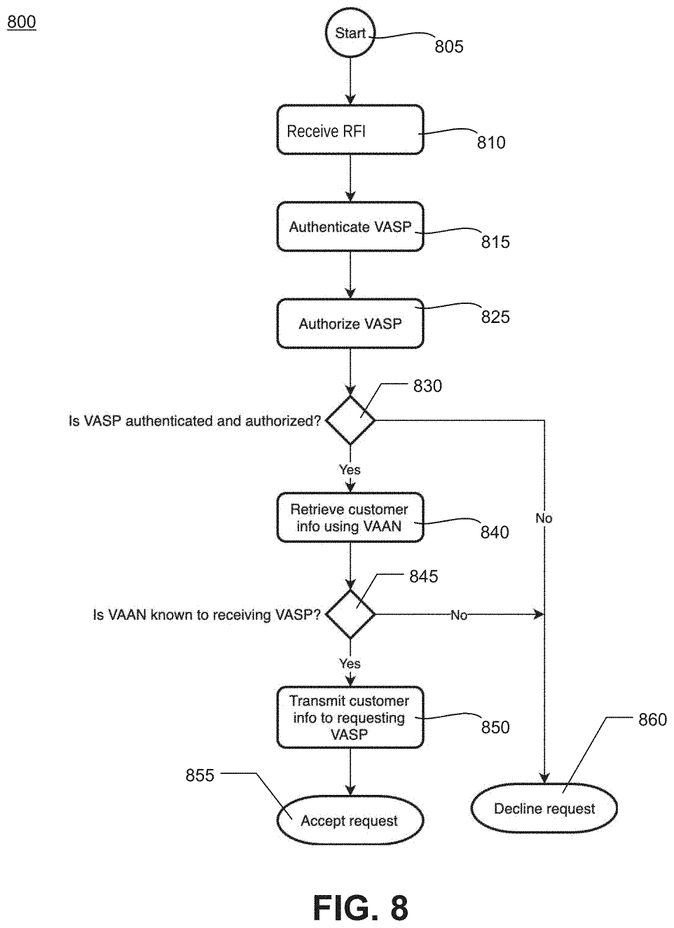

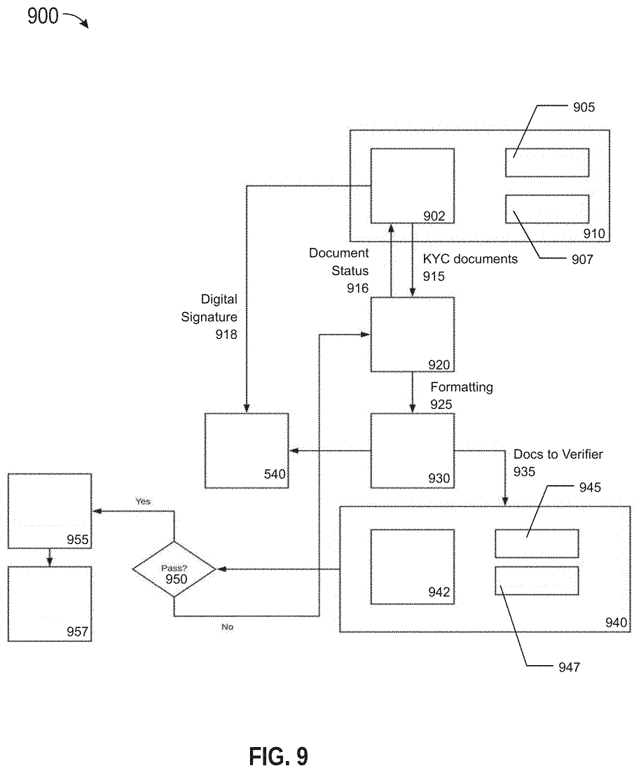

In some cases a participating VASP may want to fetch the identity behind a certain VAAN. This can be done using a Request for Identity request, or RFI in short. A VASP can initiate this request any time but the VASP receiving the request may decline the request at their own discretion. Circumstances where a request for identity may take place, for example, include during a fund transfer between a beneficiary VASP and an originator VASP, as part of an AML investigation, and/or as part of a KYC process. FIG. 8 shows a flow diagram for a method 800 of verifying an identity of a user associated with an identity value stored on a blockchain using universal payment messaging, according to an embodiment. FIG. 9 shows a simplified block diagram of a system 900 verifying an identity of a user associated with an identity value stored on a blockchain using universal payment messaging, according to an embodiment, using the method 800 described in FIG. 8. System 900 shows user device 910 in communication with blockchain server 540 and verifier system 940. Ethereum ID can accept hashes for encrypted documents, that can be passed independently of the blockchain and verified through an immutable ledger. The Verifier is defined as the entity verifying the KYC information, while application 920 is defined as the stand-alone application provided by the payment processor or financial institution. The application 920 may be a web application accessed on the server of the payment service, or may be operating locally on the user's computing device. The Sender may be defined as the consumer or business sending KYC/KYB documents for verification.

Returning to method 800, after the start 805, the RFI may be received by the blockchain server 540 from the verifier server 940 at step 810. At step 815, the requesting VASP may be authenticated by the blockchain server 540 and the authorizing application. This may be done, for example, by the authorizing application, on behalf of the customer associated with the VAAN, comparing the signature of the RFI and the VASP registry stored on the blockchain server 540 to ensure that the verifier server is registered with the VASP registry. The authorization process 825 may then be performed, in parallel with the authentication process 815, or after the requesting VASP has been authenticated. If the blockchain server 540 authenticates and the authorizing application authorizes the requesting VASP at decision block 830 as having been previously registered with the blockchain server 540 and having a valid VID, the customer information may be retrieved by the blockchain server 540 at step 840. If the requesting VASP is not authorized and authenticated at block 830, then the transfer may be declined at block 860.

At step 840, the customer info is retrieved using the VAAN (which may be associated with the customer's identity value in the blockchain server 540, using a user profile, for example). An additional check is performed at decision block 845, determining if the VAAN associated with the customer is known to the authorizing application associated with the receiving VASP. If the VAAN is known, then the customer info is transmitted to the requesting VASP at step 850, where it may be accepted; acceptance triggers the data flows displayed in system 900. If the VAAN is not known to the authorizing application at block 845, then the RFI is declined at block 860.

System 900 displays a data flow that may occur once the RFI is accepted by the authorizing application. The customer being verified submits KYC documents 915 to Application 920 using the specified formatting. The documents are then separated and signed with the users private key 918. The documents may then be compressed and encrypted according to the Verifiers public key. The application 920 may then push the transaction with the flags: -KYCrequest to the blockchain server 540. The application 920 may send the compressed file over third party networks labeled as the transaction hash 935. The verifier 942 may receive the compressed file labeled as the transaction hash, and may also receive the Ethereum ID transaction for KYC verification. The transaction and corresponding compressed file may be matched by transaction ID. KYC verification may then be processed by the Verifier at decision block 950. Upon success or failure of verification, the Verifier may a transaction to the Sender with the flags: -KYCverify-KYCStatus:Success-RiskScore:XXXXX. At block 955, the Sender is successfully verified by the Verifier, and a time stamp may be appended with the risk score at 957.

Any identity can issue a payment flag with several codes, which can act as a digital watermark preventing a payment from being further propagated by an institution. The payment flags act as a way for individuals and institutions to communicate where a payment is potentially problematic in the areas of: theft, money-laundering, terrorism, or any other form of criminal activity. Regardless XID network remains agnostic and will process payments, however nodes may decide not to process transactions that are tagged with a payment flag. Additionally, VASPS may choose not to process or honor transactions that originate from an address that have a payment flag attached. Payment flags consist of (a) stolen funds (b) currently under investigation (c) money-laundering (d) terrorism or OFAC listed (d) please inquire.

The initial goal of XID is to collaborate with existing payment networks and operate alongside them. To accomplish this we will provide a mechanism for linking external funding methods. Whenever a funding method is successfully linked, a matching VAAN will be associated to it so funds can be pushed and pulled from the source.

A common use case is to link external bank accounts such as ACH/SEPA so the beneficiary VASP can pull funds into an account managed by it. Another common use case is for VASPs initiating the request to link a funding method to disperse micro-deposits to make sure the requesting customer has access to the funding method. This is not necessary if the identity of the requesting user is known to the receiving VASP and is able to verify the signature of the request. Otherwise, the customer may be required to verify they are the legitimate owner of the funding method by verifying two small deposits made to their account. This may not be necessary in every use case, but should be determined based on a risk score.

For example, a user Alice may be trying to link her bank account into the Metal Pay application. Metal Pay and Alice's bank are both registered VASPs on the network. Metal Pay would request Alice's bank to link her bank account using the account and routing number provided. When Alice's bank authorizes the request it will issue a VAAN specific for Metal Pay and Alice's bank account. This way if Alice claims it was a fraudulent request, Alice's bank can just mark the VAAN as deactivated and effectively revoke the authorization.

TABLE 5
Issuance of a new VAAN when adding a bank account.
Alice's bank account

| Routing number | Account number |
|---|---|
| 011103093 | 128438194 |

Alice's bank issues new VAAN specific to Metal Pay
8511 39BD AB09 3E9C 01DA 9489

All payments and payment request to and from this VAAN will be handled by Alice's bank over the ACH network while still utilizing the same communication channels to update participating VASPs.

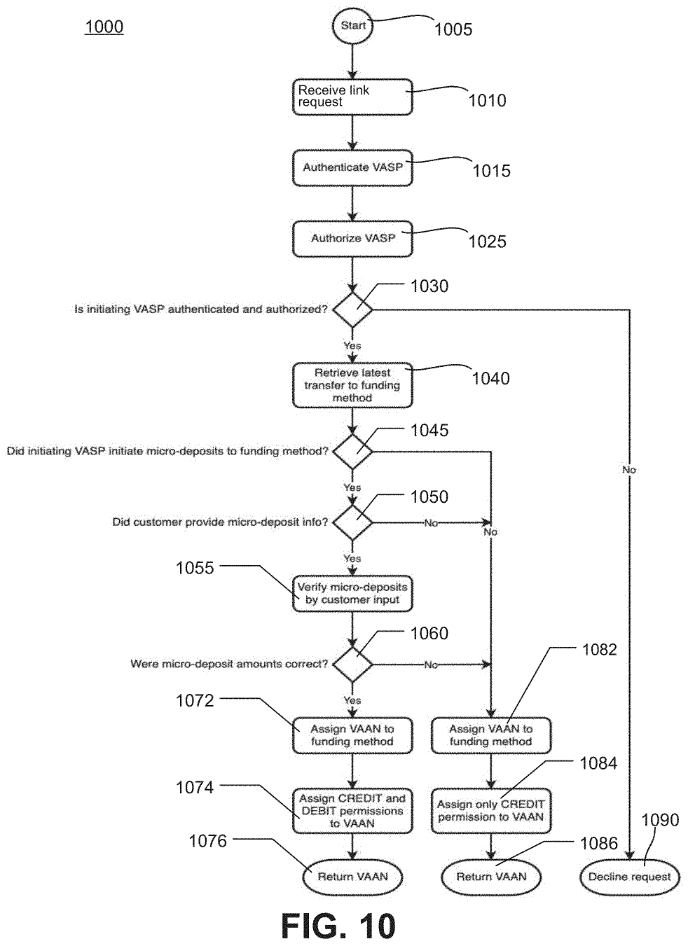

FIG. 10 shows a flow diagram for a method 1000 of associating funding methods with an identity value stored on a blockchain, according to an embodiment. After the start 1005, the request to link an account may be received by the blockchain server at step 1010. At step 1015, the requesting VASP may be authenticated by the blockchain server. This may be done, for example, by the blockchain server, on behalf of the customer associated with the VAAN, comparing the signature of the link request and the VASP registry stored on the blockchain server to ensure that the requesting VASP is registered with the VASP registry. The authorization process 1025 may then be performed, in parallel with the authentication process 1015, or after the requesting VASP has been authenticated. If the blockchain server authenticates and the authorizes the requesting VASP at decision block 1030 as having been previously registered with the blockchain server and having a valid VID, the latest transfer to funding method may be retrieved by the blockchain server at step 1040. If the requesting VASP is not authorized and authenticated at block 830, then the transfer may be declined at block 1090.

At step 1040, the latest transfer to funding method is retrieved. An additional check is performed at decision block 1045, determining if the requesting VASP intiated micro-deposits to the funding method. If yes, then decision block 1050 is triggered to determine if the customer provided micro-deposit information. This information may be verified at block 1055, and if the micro-deposit amounts are correct, then the VAAN may be returned for the requested link at block 1076, after the VAAN is assigned to the funding method at step 1072, and credit and debit permissions are assigned to the VAAN at step 1074.

If micro-deposit info is not initiated by the requesting VASP, the customer does not provide micro-deposit info, or the micro-deposit amounts do not match, then the VAAN is returned at block 1086. In this instance the VAAN is assigned to the funding method at step 1082, but only credit permissions are assigned to the VAAN at step 1084.

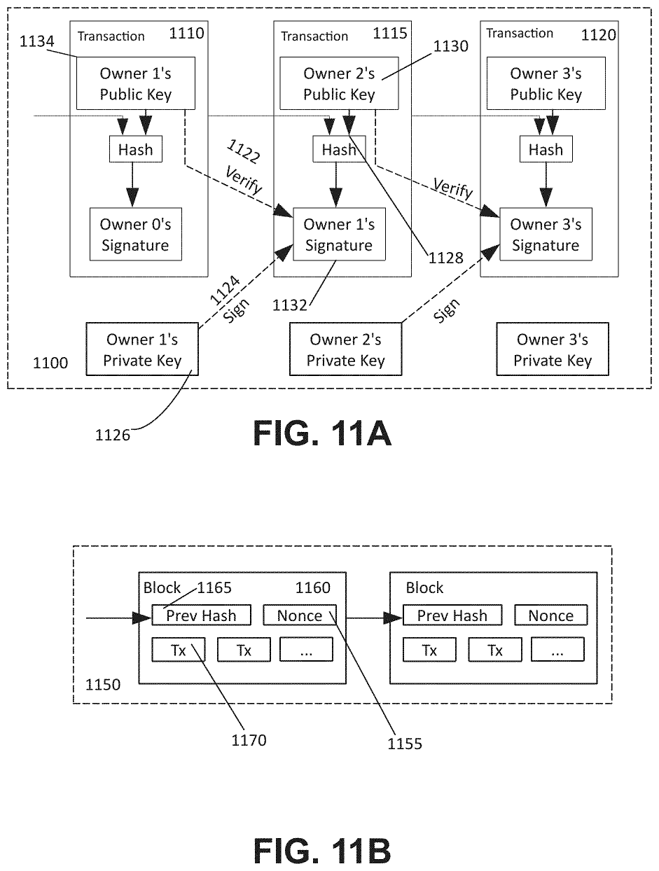

To further elaborate the use of on-chain messages described above, FIGS. 11A-B show simplified block diagrams of a chain of digital signatures 1100 of a plurality of transactions and a proof-of-work system 1150, respectively, according to various embodiments. In the digital signature chain 1100, each owner transfers amounts of the assets to the next owner by digitally signing a hash of the previous transaction involving the assets and the public key of the next owner, and adding these to the end of each asset. A payee can verify the transferred signatures to verify the chain of ownership, thus showing the asset to be legitimate. For example, in transaction 1115, the transferring owner, Owner 1, digitally signs hash 1128 of previous transaction 1110 involving the transferred asset and the public key 1130 of Owner 2, the recipient of the asset, to produce a signature for Owner 2 1132 at step 1024. To perform the step of verifying the signature, Owner 2 may use Owner 1's public key 1134 at verification step 1122. Subsequent transaction 1120 may be implemented in the same fashion as transaction 1115.

To assist in making sure a previous owner of an asset did not transact the same asset twice, a proof of work system 1150 may be implemented on each block in a ledger. For an exemplary timestamp scheme, the proof-of-work may be implementing by incrementing a nonce (number used once, a conventional cryptographic concept) 1155 in the block 1160 until a value is found that gives the block's previous hash 1165 the required zero bits initially recorded with the asset. As seen in system 1150 (implemented on a blockchain server, for example), each block 1160 also includes the first and second ring signatures, encrypted asset tag, and encrypted output amount 1170 stored on the blockchain ledger, as discussed above.

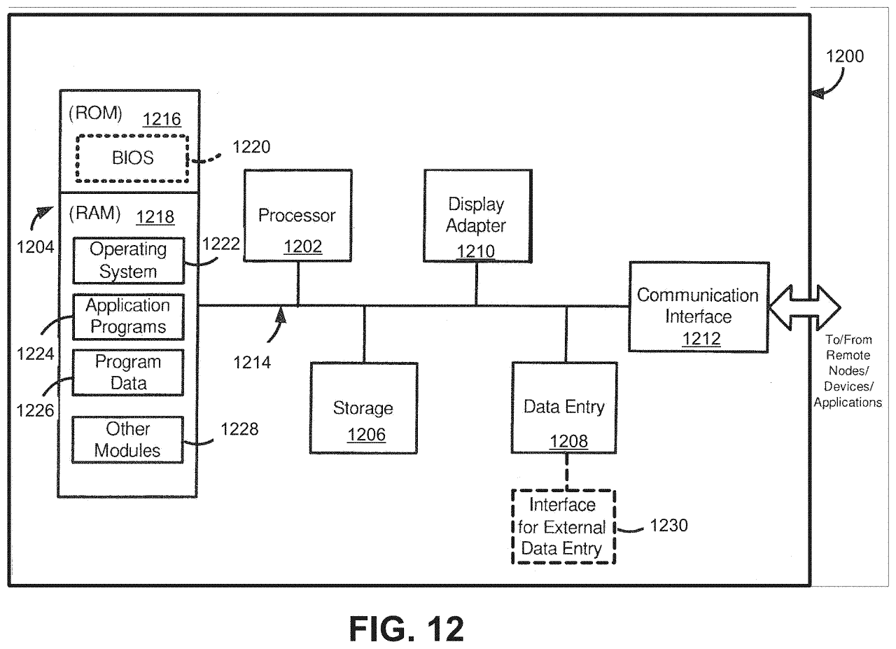

The methods and modules described above may be implemented using hardware or software running on a computing system. FIG. 12 is a block diagram of an exemplary computing system for concealing packet loss in a multi-format voice communication system, according to various embodiments of the present invention. With reference to FIG. 12, an exemplary system for implementing the subject matter disclosed herein, including the methods described above, includes a hardware device 1200, including a processing unit 1202, memory 1204, storage 1206, data entry module 1208, display adapter 1210, communication interface 1212, and a bus 1214 that couples elements 1204-1212 to the processing unit 1202.

The bus 1214 may comprise any type of bus architecture. Examples include a memory bus, a peripheral bus, a local bus, etc. The processing unit 1202 is an instruction execution machine, apparatus, or device and may comprise a microprocessor, a digital signal processor, a graphics processing unit, an application specific integrated circuit (ASIC), a field programmable gate array (FPGA), etc. The processing unit 1202 may be configured to execute program instructions stored in memory 1204 and/or storage 1206 and/or received via data entry module 1208.

The memory 1204 may include read only memory (ROM) 1216 and random access memory (RAM) 1218. Memory 1204 may be configured to store program instructions and data during operation of device 1200. In various embodiments, memory 1204 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 1204 may also include nonvolatile memory technologies such as nonvolatile flash RAM (NVRAM) or ROM. In some embodiments, it is contemplated that memory 1204 may include a combination of technologies such as the foregoing, as well as other technologies not specifically mentioned. When the subject matter is implemented in a computer system, a basic input/output system (BIOS) 1220, containing the basic routines that help to transfer information between elements within the computer system, such as during start-up, is stored in ROM 1216.

The storage 1206 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 1200.

It is noted that the methods described herein can be embodied in executable instructions stored in a non-transitory computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 1206, ROM 1216 or RAM 1218, including an operating system 1222, one or more applications programs 1224, program data 1226, and other program modules 1228. A user may enter commands and information into the hardware device 1200 through data entry module 1208. Data entry module 1208 may include mechanisms such as a keyboard, a touch screen, a pointing device, etc. Other external input devices (not shown) are connected to the hardware device 1200 via external data entry interface 1230. By way of example and not limitation, external input devices may include a microphone, joystick, game pad, satellite dish, scanner, or the like. In some embodiments, external input devices may include video or audio input devices such as a video camera, a still camera, etc. Data entry module 1208 may be configured to receive input from one or more users of device 1200 and to deliver such input to processing unit 1202 and/or memory 1204 via bus 1214.

The hardware device 1200 may operate in a networked environment using logical connections to one or more remote nodes (not shown) via communication interface 1212. The remote node may be another computer, a server, a router, a peer device or other common network node, and typically includes many or all of the elements described above relative to the hardware device 1200. The communication interface 1212 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 1212 may include logic configured to support direct memory access (DMA) transfers between memory 1204 and other devices.

In a networked environment, program modules depicted relative to the hardware device 1200, or portions thereof, may be stored in a remote storage device, such as, for example, on a server. It will be appreciated that other hardware and/or software to establish a communications link between the hardware device 1200 and other devices may be used.

It should be understood that the arrangement of hardware device 1200 illustrated in FIG. 12 is but one possible implementation and that other arrangements are possible. It should also be understood that the various system components (and means) defined by the claims, described above, and illustrated in the various block diagrams represent logical components that are configured to perform the functionality described herein. For example, one or more of these system components (and means) can be realized, in whole or in part, by at least some of the components illustrated in the arrangement of hardware device 1200. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 12. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description above, the subject matter may be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

For purposes of the present description, the terms “component,” “module,” and “process,” may be used interchangeably to refer to a processing unit that performs a particular function and that may be implemented through computer program code (software), digital or analog circuitry, computer firmware, or any combination thereof.

It should be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

In the description above and throughout, numerous specific details are set forth in order to provide a thorough understanding of the disclosure. It will be evident, however, to one of ordinary skill in the art, that the disclosure may be practiced without these specific details. In other instances, well-known structures and devices are shown in block diagram form to facilitate explanation. The description of the preferred an embodiment is not intended to limit the scope of the claims appended hereto. Further, in the methods disclosed herein, various steps are disclosed illustrating some of the functions of the disclosure. One will appreciate that these steps are merely exemplary and are not meant to be limiting in any way. Other steps and functions may be contemplated without departing from this disclosure.

What is claimed is:

1. A method for payment messaging, the method comprising:
receiving, by a server that includes a cryptographic blockchain database and is a node of an associated blockchain network, an on-chain demand message from a requesting application over a network connection, the on-chain demand message comprising a reference to an identity value, the identity value having been previously stored in the blockchain in an on-chain smart contract, and the on-chain demand message further comprising a claim against the identity value by an identity service provider and a claim for information associated with the identity value;
receiving, by the server, a request by an authorizing application over the network connection, for on-chain messages referencing a first set of identity values, the first set of identity values comprising the identity value referenced in the received on-chain demand message;
transmitting, by the server, information extracted from the received on-chain demand message to the authorizing application in response to the receiving the request, the extracted information comprising the identity value and the claim for information associated with the identity value;
receiving, by the server, an on-chain authorization message from the authorizing application, the authorization message from the authorizing application comprising an authorization to release the information associated with the identity value to the requesting application;
receiving, by the server, a request by the requesting application for on-chain messages referencing a second set of identity values, the second set of identity values including an identity value associated with the requesting application; and
transmitting, by the server, information extracted from the on-chain authorization message to the requesting application.

2. The method of claim 1, the claim for information comprising a request for a payment from a user associated with the identity value, the request being for a specified denomination and a specified amount.

3. The method of claim 2, where the authorizing application is associated with an entity that is linked to the identity value via a user profile stored on the server, the user profile further specifying that the entity is associated with the specified denomination for the identity value.

4. The method of claim 3, the on-chain authorization message indicating that the entity associated with the authorizing application authorizes release of the specified amount of the specified denomination.

5. The method of claim 2, the on-chain demand message comprising the identity value, the specified denomination, and the specified amount.

6. The method of claim 1, the claim for information comprising a grant authorizing payment to a user associated to the identity value, the grant being for a specified denomination and a specified amount.

7. The method of claim 1, the claim for information comprising a request to confirm an identity of a user associated to the identity value, the on-chain authorization message comprising a confirmation that the identity of the user matches data managed by a service in communication with the authorizing application.

8. The method of claim 7, further comprising automatically generating, by the server, a identity verification data structure, receiving a digital signature from the requesting application, encrypting the identity verification data structure with the digital signature, storing, by the server, the signed identity verification data structure, and, in response to receiving the on-chain authorization message, adding a flag to a user profile associated with the identity value, the user profile being stored on the server.

9. A computer program product comprising computer-readable program code to be executed by one or more processors when retrieved from a non-transitory computer-readable medium, the one or more processors operating on a server that includes a cryptographic blockchain database that is also a node of an associated blockchain network, the program code including instructions to:
receive an on-chain demand message from a requesting application over a network connection, the on-chain demand message comprising a reference to an identity value, the identity value having been previously stored in the blockchain in an on-chain smart contract, and the on-chain demand message further comprising a claim against the identity value by an identity service provider and a claim for information associated with the identity value;
receive a request by an authorizing application over the network connection, for on-chain messages referencing a first set of identity values, the first set of identity values comprising the identity value referenced in the received on-chain demand message;
transmit information extracted from the received on-chain demand message to the authorizing application in response to the receiving the request, the extracted information comprising the identity value and the claim for information associated with the identity value;
receive an on-chain authorization message from the authorizing application, the authorization message from the authorizing application comprising an authorization to release the information associated with the identity value to the requesting application;
receive a request by the requesting application for on-chain messages referencing a second set of identity values, the second set of identity values including an identity value associated with the requesting application; and
transmit information extracted from the on-chain authorization message to the requesting application.

10. The computer program product of claim 9, the claim for information comprising a request for a payment from a user associated with the identity value, the request being for a specified denomination and a specified amount.

11. The computer program product of claim 10, where the authorizing application is associated with an entity that is linked to the identity value via a user profile associated with the identity value, the user profile further specifying that the entity is associated with the specified denomination for the identity value.

12. The computer program product of claim 11, the on-chain authorization message indicating that the entity associated with the authorizing application authorizes release of the specified amount of the specified denomination.

13. The computer program product of claim 10, the on-chain demand message comprising the identity value, the specified denomination, and the specified amount.

14. The computer program product of claim 9, the claim for information comprising a grant authorizing payment to a user associated to the identity value, the grant being for a specified denomination and a specified amount.

15. The computer program product of claim 9, the claim for information comprising a request to confirm an identity of a user associated to the identity value, the on-chain authorization message comprising a confirmation that the identity of the user matches data managed by a service in communication with the authorizing application

16. The computer program product of claim 15, the program code further including instructions to automatically generate a identity verification data structure, receive a digital signature from the requesting application, encrypt the identity verification data structure with the digital signature, store the signed identity verification data structure, and, in response to receiving the on-chain authorization message, add a flag to a user profile associated with the identity value, the user profile being stored on the server.

17. A system for payment messaging comprising:
one or more processors; and
a non-transitory computer readable medium storing a plurality of instructions, which when executed, cause the one or more processors to:
receive an on-chain demand message from a requesting application over a network connection, the on-chain demand message comprising a reference to an identity value, the identity value having been previously stored in the blockchain in an on-chain smart contract, and the on-chain demand message further comprising a claim against the identity value by an identity service provider and a claim for information associated with the identity value;
receive a request by an authorizing application over the network connection, for on-chain messages referencing a first set of identity values, the first set of identity values comprising the identity value referenced in the received on-chain demand message;
transmit information extracted from the received on-chain demand message to the authorizing application in response to the receiving the request, the extracted information comprising the identity value and the claim for information associated with the identity value;
receive an on-chain authorization message from the authorizing application, the authorization message from the authorizing application comprising an authorization to release the information associated with the identity value to the requesting application;
receive a request by the requesting application for on-chain messages referencing a second set of identity values, the second set of identity values including an identity value associated with the requesting application; and
transmit information extracted from the on-chain authorization message to the requesting application.

18. The system of claim 17, the claim for information comprising a request for a payment from a user associated with the identity value, the request being for a specified denomination and a specified amount.

19. The system of claim 17, where the authorizing application is associated with an entity that is linked to the identity value via a user profile associated with the identity value, the user profile further specifying that the entity is associated with the specified denomination for the identity value.

20. The system of claim 19, the on-chain authorization message indicating that the entity associated with the authorizing application authorizes release of the specified amount of the specified denomination.
